(19) United States
(12) Patent Application Publication
(10) Pub. No.: US 2003/0158679 A1
(43) Pub. Date: Aug. 21, 2003

(54) Anomaly detection system

(75) Inventor: Toru Fukushima, Tokyo (JP)

Correspondence Address: McDermott, Will & Emery, 600 13th Street, N.W., Washington, DC, 20005-3096, US

(73) Assignee: Mitsubishi Denki Kabushiki Kaisha

(21) Appl. No.: 10/253,813

(22) Filed: Sep. 25, 2002

(30) Foreign Application Priority Data
Feb. 18, 2002 (JP) 2002-040621

(51) Int. Cl. G06F 19/00

(52) U.S. Cl. 702/81

(57) ABSTRACT

An anomaly detection system that can detect physical-positional anomalies or probably abnormal symptoms in a product on a wafer even if an inspector passively monitors map data or anomalies in a unit of test such as a lot of products do not reach a predetermined anomaly reference value. An input module 32 of an anomaly detection system 30 inputs positional data 15 about the position of each of a plurality of semiconductor product on a wafer from a wafer prober and inputs a predetermined test result data 25 about the semiconductor product from an LSI tester 20 each time a test on the plurality of semiconductor products. A detector 33 detects a predetermined abnormal value pattern in a plurality of semiconductor products having a predetermined abnormal value in the predetermined test result data 25 inputted by the input module 32. An output section 34 outputs detection result data 35 (an alarm if the abnormal pattern is detected).

### BACKGROUND OF THE INVENTION

1. Field of the Invention

The present invention relates to an anomaly detection system for detecting anomalies in a plurality of semiconductor products formed on a wafer.

2. Description of Related Art

Examples of anomalies in a plurality of micro products such as semiconductor devices fabricated on a single wafer anomalies that can be observed in terms of their physical position during a manufacturing process or inspection process include various anomalies such as damage due to abnormal implant or abnormal electric discharge in a wafer processing process and anomalies due to a test jig problem in a wafer probe test process. To inspect the plurality of semiconductor devices or products formed on a single wafer for anomalies, various types of map data have been used based on positional information about individual semiconductor devices indicated by two-dimensional coordinates (X-Y coordinates) on the wafer and results of tests conducted on them. Examples of the map data include map data indicating whether products are defective or not together with positional information about them, map data indicating categories of non-defective or defective products together with positional information, and map data indicating product test result data itself.

FIG. 7 shows a block diagram of a detection system for detecting anomalies in semiconductor devices according to a related art. In FIG. 7, reference number 10 indicates a wafer prober for obtaining positional information about semiconductor devices, reference number 20 indicates an LSI tester for testing the semiconductor devices, 15 indicates positional data (such as X-Y coordinates) for each semiconductor device obtained through the wafer prober 10, reference number 25 indicates data (hereinafter called “test result data”) indicating the results of the test conducted with the LSI tester 20, and 5 indicates an analysis tool which the positional data 15 and test result data 25 are inputted into and provides map data 7 as the result of the analysis. Whether each individual semiconductor device is a non-defective product 9 or defective product 8 is indicated in the corresponding position of the device on the map data 7. An inspector monitors the map data 7 to determine whether a semiconductor device is a defective or not.

As described above, analysis tools 5 for generating map data 7 have been available. However, there has been a problem with the tools that an inspector cannot find anomalies in semiconductor devices if he/she passively monitors the map data 7, even though the anomalies were obvious by a glance at the map data 7. Furthermore, even if the inspector of semiconductor devices is actively involved in the collection or output of the test result data 25, the number of anomalies or percent defective in products tested on a wafer or lot basis alone may provide extremely low anomaly detection sensitivity. Thus, if anomalies in a unit of test such as a lot of products do not reach a predetermined anomaly reference value, it is likely that the anomalies cannot be detected. That is, there is a problem that physical-positional anomalies or provably abnormal symptoms in a product on a wafer cannot be detected.

### SUMMARY OF THE INVENTION

The present invention has been made to solve these problems and it is an object of the present invention to provide an anomaly detection system that can detect physical-positional anomalies or probably abnormal symptoms in a product on a wafer even if an inspector passively monitors map data or anomalies in a unit of test such as a lot of products do not reach a predetermined anomaly reference value.

According to a first aspect of the present invention, there is provided an anomaly detection system for detecting anomalies in a plurality of semiconductor products formed on a wafer, comprising: input means for inputting positional data about the position of each of the semiconductor products on the wafer and a predetermined test result data about the semiconductor product; and detection means for detecting a predetermined abnormal value pattern based on the positional data in a plurality of semiconductor products in which the predetermined test result data inputted by the input means has a predetermined abnormal value.

According to a second aspect of the present invention, there is provided a computer program code embodied in a computer readable recording medium, the computer program code is to detect anomalies in a plurality of semiconductor products formed on a wafer, the computer program code comprising: computer program code segment means for inputting positional data about the position of each of the semiconductor products on the wafer and a predetermined test result data about the semiconductor product; and computer program code segment means for detecting a predetermined abnormal value pattern based on the positional data in a plurality of semiconductor products in which the predetermined test result data inputted by the computer program code segment means for inputting has a predetermined abnormal value.

According to a third aspect of the present invention, there is provided a computer-readable recording medium which has stored a computer program code according to the present invention.

The above and other objects, effects, features and advantages of the present invention will become more apparent from the following description of the embodiments thereof taken in conjunction with the accompanying drawings.

### BRIEF DESCRIPTION OF THE DRAWINGS

FIG. 1 shows a block diagram of an anomaly detection system according to a first embodiment of the present invention.

FIGS. 2A through 2G show abnormal value patterns detected by the anomaly detection system 30 of the present invention.

FIG. 3 shows a block diagram of an anomaly detection system in second through fourth embodiments of the present invention

FIGS. 4A and 4B show examples of detection result data 35 outputted by the output module 34 according to the fourth embodiment of the present invention.

FIG. 5 shows a flowchart of a program for detecting anomalies in a plurality of semiconductor products formed on a wafer as described with respect to the first through fourth embodiments of the present invention.

FIG. 6 illustrates a computer for performing the functions of the components such as the input module 32 and detector 33 of the anomaly detection system 30 according to the present invention.

FIG. 7 shows a block diagram of a detection system for detecting anomalies in semiconductor devices according to a related art.

### DETAILED DESCRIPTION OF THE PREFERRED EMBODIMENTS

Embodiments of the present invention will be described below with reference to the accompanying drawings. It is noted that the same reference symbols in the drawings denote the same or corresponding components.

First Embodiment

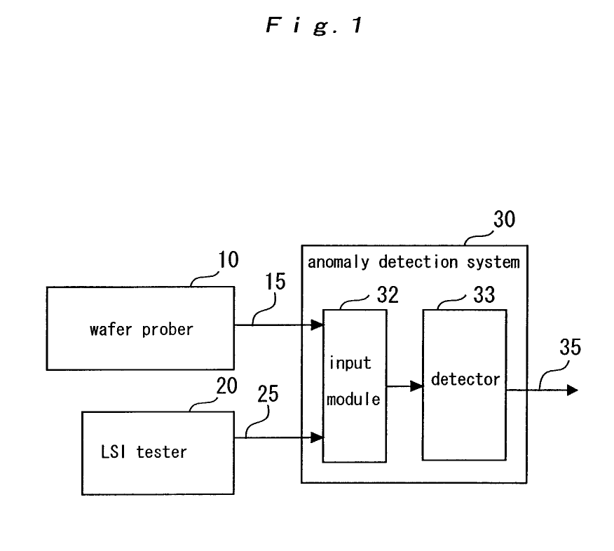

FIG. 1 shows a block diagram of an anomaly detection system according to a first embodiment of the present invention. In FIG. 1, reference number 10 indicates a wafer prober for obtaining positional information about semiconductor products, 20 indicates an LSI tester for testing the semiconductor products, 15 indicates positional data (such as X-Y coordinates) obtained by the wafer prober 10, and 25 indicates data on results of a test conducted with the LSI tester 20. The positional data 15 may be two-dimensional coordinates data of the semiconductor products on the wafer. The test result data 25 may be pass/fail information indicating whether a product passes or fails a predetermined test, for example, and, in addition to this information, may include fail category data indicating the category of a fail and test data itself. Reference number 30 indicates an anomaly detection system for detecting anomalies in a plurality of semiconductor products fabricated on a wafer according to the present invention. The anomaly detection system 30 has an input module (input means) 32 through which the positional data 15 about the position of each semiconductor product on the wafer is inputted from the wafer prober and test result data 25 about the semiconductor product is inputted from the LSI tester 20, each time a test on the plurality of semiconductor products is conducted. The positional data 15 and the test result data 25 inputted through the input module 32 are collectively sent to a detector 33. The detector 33 detects a predefined abnormal value pattern of a plurality of semiconductor products having a given abnormal value in the test result data 25, based on the positional data 15 about the plurality of semiconductor products and outputs detection result data 35. If an anomaly is detected, the detection result data 35 provides an alarm. The predefined abnormal value pattern detected may be a predefined two-dimensional geometry on the wafer as will be described below.

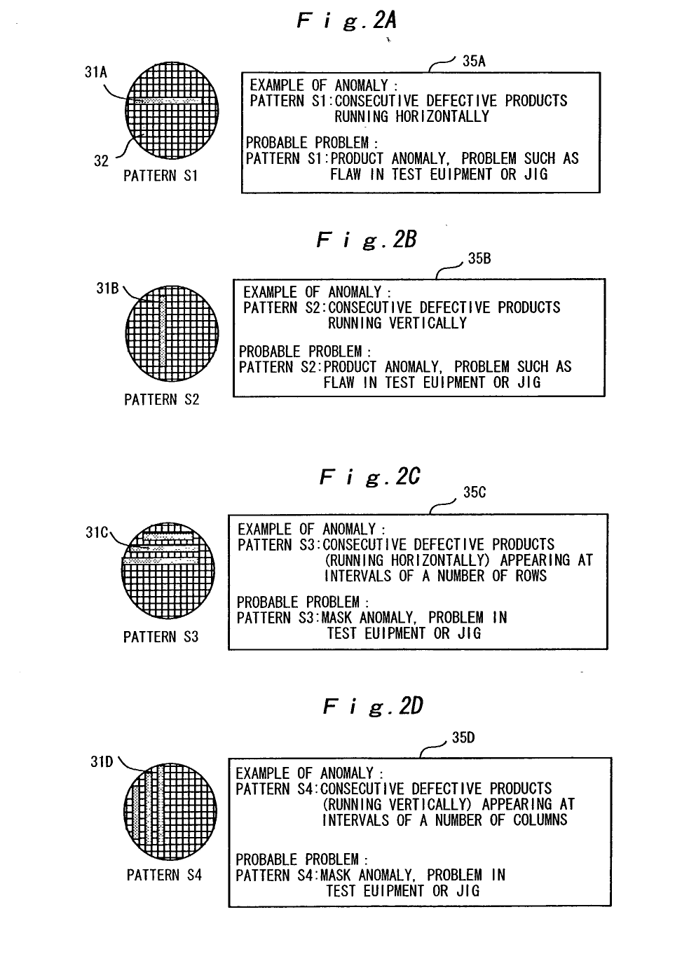

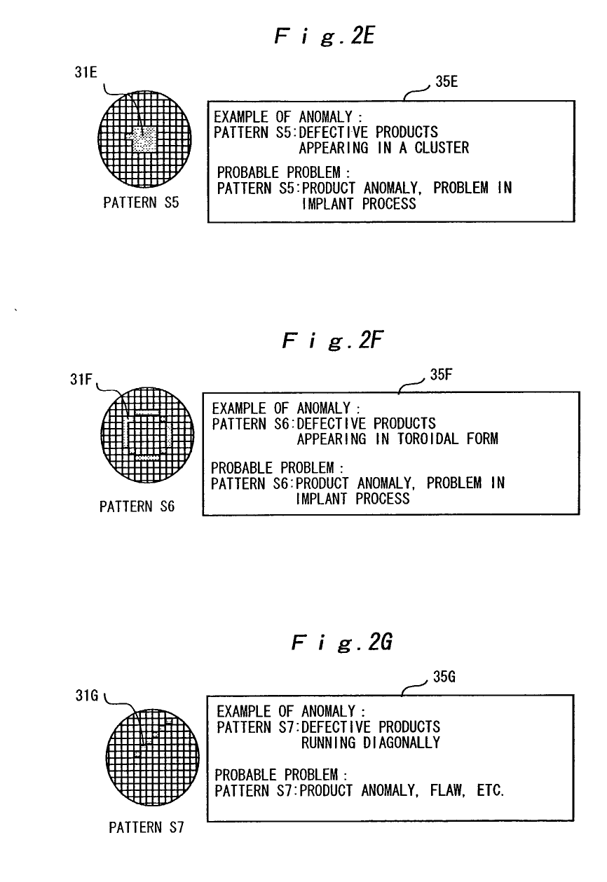

FIGS. 2A through 2G show abnormal value patterns detected by the anomaly detection system 30 of the present invention. FIG. 2A shows abnormal value pattern Si. Reference number 22 indicates a non-defective product and 31A (a shaded portion in FIG. 2A) indicates a series of defective products. For clarity, reference number 22 is omitted in diagrams showing abnormal value pattern S2 or S7, which will be described below. As shown in inspection result data 35A, abnormal value pattern S1 is a physical-positional abnormal pattern in which consecutive defective products 31A run horizontally. It is indicated that probable problems causing this abnormal value pattern S1 may be an anomaly or flaw in the products due to a problem in test equipment or a jig. While the probable problems are included in the detection result data 35A in FIG. 2A, they may be determined by an inspector based on abnormal value pattern SI. This also applies to abnormal patterns S2 through S7, which will be described below.

FIG. 2B shows abnormal value pattern S2. Reference number 31B (a shaded portion in FIG. 2B) indicates a series of defective products. Abnormal value pattern S2 is a physical-positional abnormal pattern in which consecutive defective products 31B run vertically, as shown in inspection result data 35B. It is indicated that probable problems causing this abnormal value pattern S2 may be an anomaly or flaw in the products due to a problem in test equipment or a jig.

FIG. 2C shows abnormal value pattern S3. Reference number 31C (a shaded portion in FIG. 2C) indicates a series of defective products. Abnormal value pattern S3 is a physical-positional abnormal pattern in which consecutive defective products 31C running horizontally appear at intervals of a plurality of rows as shown in inspection result data 35C. It is indicated that probable problems causing this abnormal value pattern S3 may be an anomaly in mask or a problem in test equipment or a jig.

FIG. 2D shows abnormal value pattern S4. Reference number 31D (a shaded portion in FIG. 2D) indicates a series of defective products. Abnormal pattern value S4 is a physical-positional abnormal pattern in which consecutive defective products 31D running vertically appear at intervals of a plurality of columns, as shown in inspection result data 35D. It is indicated that probable problems causing this abnormal value pattern S4 may be an anomaly in mask or a problem in test equipment or a jig.

FIG. 2E shows abnormal value pattern S5. Reference number 31E (a shaded portion in FIG. 2E) indicates a series of defective products. Abnormal value pattern S5 is a physical-positional abnormal pattern in which defective products 31E appear in a cluster, as shown in inspection result data 35E. It is indicated that probable problems causing this abnormal value pattern S5 may be a product anomaly or a problem in an implant process.

FIG. 2F shows abnormal value pattern S6. Reference number 31F (a shaded portion in FIG. 2F) indicates a series of defective products. Abnormal value pattern S6 is a physical-positional abnormal pattern in which defective parts 31F appear in toroidal form as shown in inspection result data 35F. It is indicated that probable problems causing this abnormal value pattern S6 may be a product anomaly or a problem in an implant process.

FIG. 2G shows abnormal value pattern S7. Reference number 31G (a shaded portion in FIG. 2G) indicates a series of defective products. Abnormal value pattern S7 is a physical-positional abnormal pattern in which consecutive defective products 31G run diagonally as shown in inspection result data 35G. It is indicated that probable problems causing this abnormal value pattern S7 may be a product anomaly or a flaw.

Abnormal value patterns S1 through S7 described above are provided for illustrative purpose only. Abnormal patterns that can be detected by the anomaly detection system 30 of the present invention are not limited to these patterns.

According to the first embodiment, the input module 32 of the anomaly detection system 30 inputs the positional data 15 about each semiconductor product on a wafer from the wafer prober and inputs test result data 25 about the semiconductor product from the LSI tester 20 each time a plurality of semiconductor products are tested. The detector 33 in the anomaly detection system 30 detects a predefined abnormal value pattern of a plurality of semiconductor products having a given abnormal value in the test result data 25 inputted by the input module 32 based on the positional data 15 about the plurality of semiconductor products and outputs detection result data 35. If an anomaly is detected, the detection result data 35 provides an alarm. Thus, the anomaly detection system 30 according to the present invention allows physical-positional anomalies or probably abnormal symptoms in the semiconductor devices to be automatically detected. Therefore, even if an inspector passively monitors map data, she/he can detect the physical-positional anomalies or probably abnormal symptoms in the products on the wafer.

Second Embodiment

The function of detecting anomalies in terms of whether semiconductor products are non-defective products 22 or defective products 31A-31G has been illustrated with respect to the first embodiment. The function of determining categories of anomalies will be described below with respect to a second embodiment.

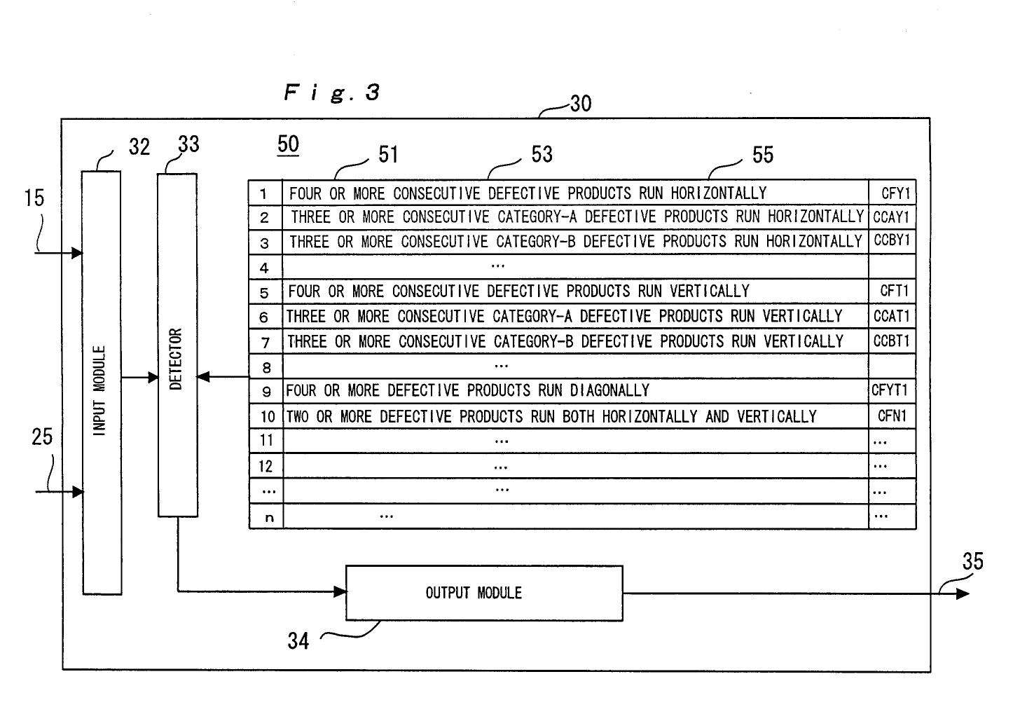

FIG. 3 shows a block diagram of an anomaly detection system in second through fourth embodiments of the present invention. Description of elements labeled with the same reference numbers in FIG. 3 as those in FIG. 1 will be omitted. Reference number 55 in FIG. 3 indicates abnormal pattern category identifiers and 34 indicates an output module, which will be described later with respect to the third and fourth embodiments. The second embodiment is different from the first embodiment in that an abnormal pattern registration section 50 in which predefined abnormal value patterns indicated in given test result data 25 are further registered. As shown in FIG. 3, registration numbers 51 and abnormal value patterns 53 associated with the numbers are registered previously in the abnormal pattern registration section 50. A detector 33 compares the test result data 25 inputted from an LSI tester 20 through an input module 32 and positional data 15 inputted from wafer prober 10 with predefined abnormal value patterns 53 indicated by predetermined test result data registered in the registration module 50 to detect a predefined abnormal value pattern 53 based on the positional data 15 about a plurality of semiconductor products. The abnormal value patterns 53 contain the types of anomaly or abnormal value (such as “defective products running horizontally”, for example) and the degrees of anomalies or abnormal values are recorded (such as “more than four defective products”, for example) as shown in FIG. 3.

As described above, the abnormal pattern registration section 50 in which the predefined abnormal value patterns indicated in test result data 25 may be registered is further provided according to the second embodiment. The abnormal pattern registration section 50 may have any type or degree of anomalies. Thus, any sensitivity to detect anomalies can be adjusted and any types (categories) or appearances of anomalies can be set.

Third Embodiment

Abnormal pattern category identifiers (the identifiers of abnormal value patterns) 55 that allow individual abnormal patterns 53 to be identified can be provided in the abnormal pattern registration section 50 as shown in FIG. 3 (for example, the abnormal pattern category identifier 55 of a pattern, “four or more defective products running horizontally” is “CFY1”). The abnormal pattern category identifiers 55 can facilitate the identification of an abnormal value pattern 53 detected by the anomaly detection system 30.

As described above, abnormal pattern category identifiers 55 can be provided in the abnormal pattern registration section 50 according to the third embodiment. Thus, an abnormal value pattern 53 detected by the anomaly detection system 30 can be readily identified, enabling a finer anomaly control.

Fourth Embodiment

The anomaly detection system 30 can further include an output module (output means) 34 for outputting abnormal value patterns 53 detected by a detector 33 on a predetermined unit of test basis (for example, a wafer or lot) as shown in FIG. 3.

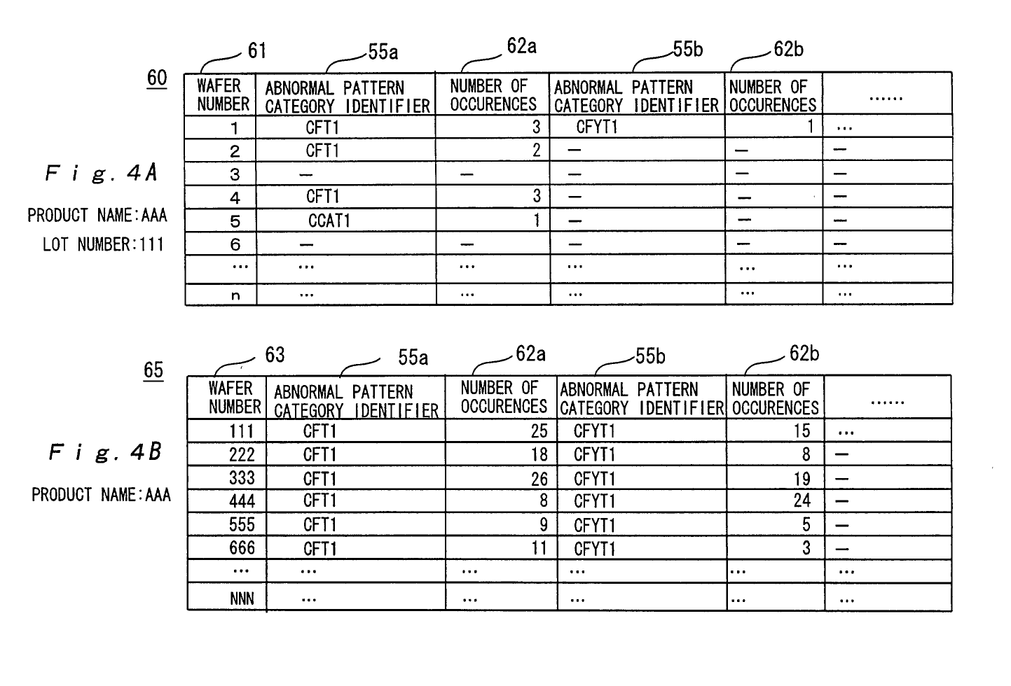

FIGS. 4A and 4B show examples of detection result data 35 outputted by the output module 34 according to the fourth embodiment of the present invention. FIG. 4A shows an example 60 in which detection result data 35 is outputted by wafer. FIG. 4B shows an example 65 in which the detection result data 35 is outputted by lot. In FIGS. 4A and 4B, reference number 61 indicates wafer numbers, 55a and 55b indicate abnormal pattern category identifiers (for example “CFT1”), 62a and 62b indicate the number of occurrences detected as a pattern identified by the abnormal pattern category identifier 55a, and 63 indicates lot numbers.

As described above, the output module 34 outputs abnormal value patterns 53 can be outputted on a predetermined unit of test basis according to the fourth embodiment. Thus, the category of an abnormal values detected can be analyzed on a wafer basis. The tendency of abnormality in lots (a certain abnormal value pattern 53 occurs every other lot), for example, can be detected and various anomaly handlings such as collecting detection result data 35 per predetermined period can be performed. As a result, physical-positional anomalies or probable abnormal symptoms in products formed on a wafer can be detected even if anomalies in the products in a unit of test such as a lot do not reach a predetermined anomaly reference value. This can help finding the cause of the anomalies.

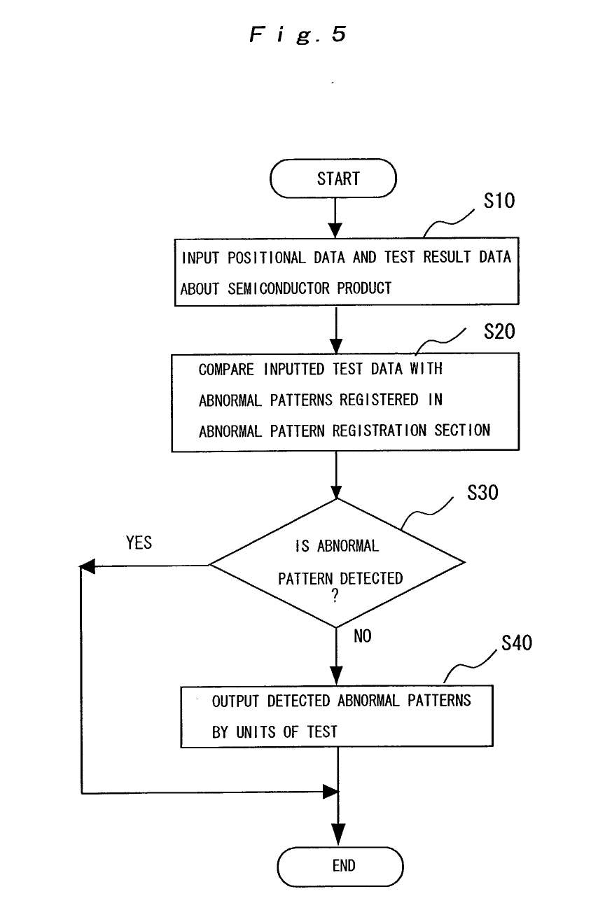

FIG. 5 shows a flowchart of a program for detecting anomalies in a plurality of semiconductor products formed on a wafer as described with respect to the first through fourth embodiments of the present invention. As shown in FIG. 5, first, positional data 15 about the position of each semiconductor product on a wafer and given test result data 25 about the semiconductor product are inputted (step S10: input step). Then, the positional data 15 and test result data 25 inputted at step S10 (input step) are compared with predefined abnormal value patterns 53 indicated by predetermined test result data registered in the registration module 50 to detect any of the abnormal patterns 53 based on positional data 15 about plurality of semiconductors (step S20: detection step). If a abnormal value pattern 53 is detected at step S20, the detected abnormal value pattern 53 is outputted on a predetermined unit of test basis (step S40: output step), then the process ends. If none of the abnormal value pattern 53 is detected at step S30, the process ends. Steps S10 and S30 in the flowchart correspond to the first embodiment. These steps plus step S20 correspond to the second and third embodiments and the process from step S10 to S40 corresponds to the fourth embodiment.

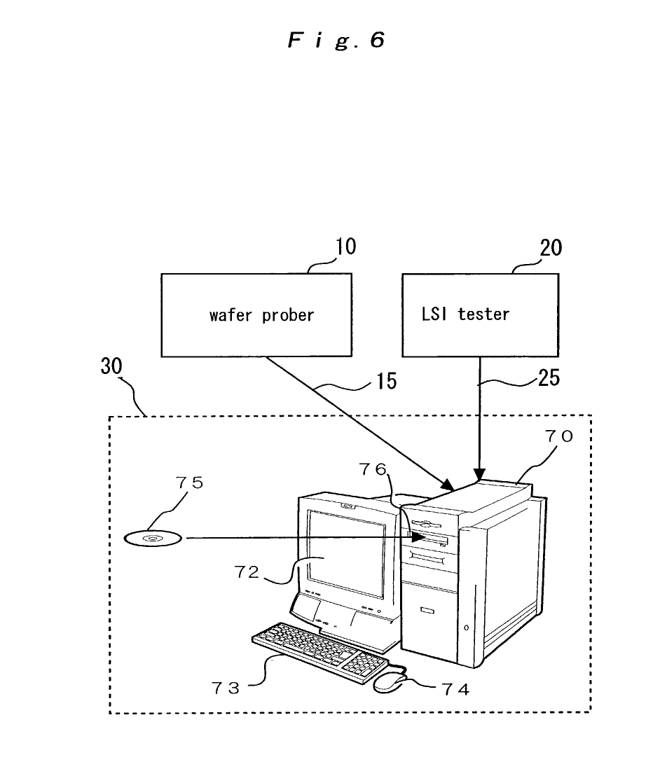

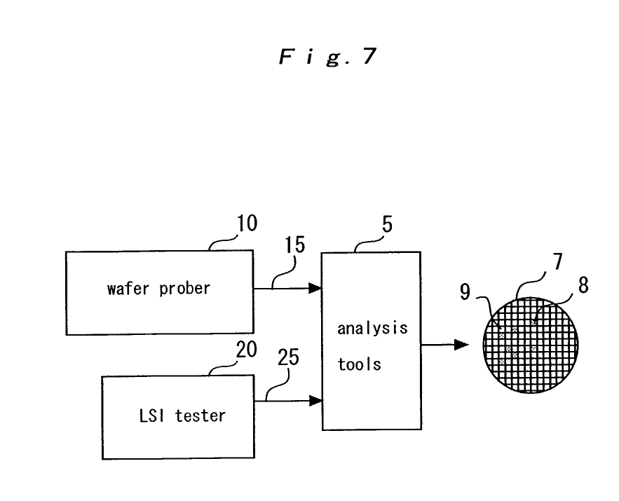

FIG. 6 illustrates a computer for performing the functions of the components such as the input module 32 and detector 33 of the anomaly detection system 30 according to the present invention. The description of elements labeled with the same reference numbers in FIG. 6 as those in FIG. 1 will be omitted. Reference number 75 indicates the main unit containing a memory device (not shown) such as RAM and a CPU (not shown) for performing functions of the anomaly detection system 30 of the present invention, 72 indicates a display for displaying detection result data 35, 73 indicates a keyboard for inputting desired data, 74 indicates a pointing device such as a mouse, 75 indicates a recording medium on which a computer program of the present invention is recorded for embodying the functions described above with respect to the embodiments of the present invention, and 76 indicates a drive receiving the recording medium 75. The recording medium 75 is inserted into the drive 76, the computer program is loaded into the memory device such as RAM, and the computer program is executed by the CPU in the main unit 70 to achieve the objects of the present invention. The computer program itself embodies the novel functions of the anomaly detection system 30 of the present invention and the recording medium on which the computer program is recorded also constitutes the present invention. The recording medium 75 on which the computer program is recorded may be a CD-ROM, DVD, optical disk, memory card, floppy disk, hard disk or ROM, for example.

As described above, the anomaly detection system according to the present invention allows physical-positional anomalies or probably abnormal symptoms in semiconductor products to be automatically detected. Thus, physical-positional anomalies or probably abnormal symptoms in a product on a wafer can be detected even if an inspector passively monitors map data or anomalies in a unit of test such as a lot of products do not reach a predetermined anomaly reference value.

Here, the anomaly detection system may further comprise an abnormal pattern registration section in which the predetermined abnormal value pattern indicated by the predetermined test result data is registered, wherein the detection means detects the predetermined abnormal value pattern based on the positional data about the plurality of semiconductor products, the detection being based on the comparison between the predetermined test result data and the positional data inputted by the input means and the predetermined abnormal value pattern indicated by the predetermined test result data registered in the registration section.

In the anomaly detection system, the predetermined abnormal value pattern registered in the abnormal pattern registration section may contain the type of a abnormal value indicated by the predetermined test result data, the degree of the abnormal value, and the identifier of the abnormal value pattern.

Here, the anomaly detection system may further comprise output means for outputting the predetermined abnormal value pattern detected by the detection means on a predetermined unit of test basis.

In the anomaly detection system, the positional data inputted by the input means may be two-dimensional coordinates data of the semiconductor products on the wafer and the predetermined abnormal value pattern detected by the detection means is a predetermined two-dimensional geometry on the wafer.

Here, the computer program code may further comprise an abnormal pattern registration section in which the predetermined abnormal value pattern indicated by the predetermined test result data is registered, wherein the computer program code segment means for detecting detects the predetermined abnormal value pattern based on the positional data about the plurality of semiconductor products, the detection being based on the comparison between the predetermined test result data and the positional data inputted by the computer program code segment means for inputting and the predetermined abnormal value pattern indicated by the predetermined test result data registered in the registration section.

Here, the computer program code may further comprise computer program code segment means for outputting the predetermined abnormal value pattern detected by the computer program code segment means for detecting on a predetermined unit of test basis.

The present invention has been described in detail with respect to various embodiments, and it will now be apparent from the foregoing to those skilled in the art that changes and modifications may be made without departing from the invention in its broader aspects, and it is the invention, therefore, in the appended claims to cover all such changes and modifications as fall within the true spirit of the invention.

The entire disclosure of Japanese Patent Application No. 2002-040621 filed on Feb. 18, 2002 including specification, claims, drawings and summary are incorporated herein by reference in its entirety.

What is claimed is:

1. An anomaly detection system for detecting anomalies in a plurality of semiconductor products formed on a wafer, comprising:
input means for inputting positional data about the position of each of said semiconductor products on the wafer and a predetermined test result data about the semiconductor product; and
detection means for detecting a predetermined abnormal value pattern based on the positional data in a plurality of semiconductor products in which the predetermined test result data inputted by said input means has a predetermined abnormal value.

2. The anomaly detection system according to claim 1, further comprising an abnormal pattern registration section in which said predetermined abnormal value pattern indicated by said predetermined test result data is registered,
wherein said detection means detects the predetermined abnormal value pattern based on the positional data about the plurality of semiconductor products, the detection being based on the comparison between
the predetermined test result data and the positional data inputted by said input means and
the predetermined abnormal value pattern indicated by the predetermined test result data registered in said registration section.

3. The anomaly detection system according to claim 2, wherein said predetermined abnormal value pattern registered in said abnormal pattern registration section contains the type of a abnormal value indicated by the predetermined test result data, the degree of the abnormal value, and the identifier of the abnormal value pattern.

4. The anomaly detection system according to claim 1, further comprising output means for outputting the predetermined abnormal value pattern detected by said detection means on a predetermined unit of test basis.

5. The anomaly detection system according to claim 1, wherein the positional data inputted by said input means is two-dimensional coordinates data of the semiconductor products on the wafer and thepredetermined abnormal value pattern detected by said detection means is a predetermined two-dimensional geometry on the wafer.
